(19) United States
(12) Patent Application Publication
(10) Pub. No.: US 2016/0092537 A1
(43) Pub. Date: Mar. 31, 2016

(54) POLLING BASED SYNCHRONIZATION IN MANAGED NETWORKS

(71) Applicant: ALCATEL-LUCENT CANADA, INC, OTTAWA (CA)

(72) Inventors: Elvis Vieira, Ottawa (CA); Tibor Fasanga, Stittsville (CA); Kevin Ryan, Richmond (CA); Sanjeev Singal, Ottawa (CA); Joji Joseph, Ottawa (CA)

(21) Appl. No.: 14/502,456

(22) Filed: Sep. 30, 2014

(51) Int. Cl. G06F 17/30

(52) U.S. Cl. CPC G06F 17/30581; G06F 17/30345

(57) ABSTRACT

Various exemplary embodiments relate to a method for managing the synchronization of data in a management database on a network node, the method including receiving an update request including one or more requested variables and an update tracking value, wherein each requested variable includes a requested variable identifier; determining a set of updated variables, wherein each updated variable includes an update indicator greater than the update tracking value, an updated variable identifier indicating at least one of the requested variables, and an updated variable value; and sending an update response including for each of the set of updated variables, the updated variable identifier and the updated variable value.

### CROSS-REFERENCE TO RELATED APPLICATIONS

This application is related to co-pending application U.S. application Ser. No. 14/502,254 filed on same date herewith, Attorney Docket Number ALC 3919, “Event-Driven Synchronization in SNMP Managed Networks,” which is hereby incorporated by reference for all purposes as if fully set forth herein.

### TECHNICAL FIELD

Various exemplary embodiments disclosed herein relate generally to data synchronization in managed networks.

### BACKGROUND

Simple Network Management Protocol (SNMP) is a set of standards within in the Internet Protocol Suite standard for managing devices on IP networks as defined by the Internet Engineering Task Force (IETF). SNMP is used in network management systems to administratively monitor network-attached devices such as, for example, routers, switches, bridges, hubs, servers and server racks, workstations, printers, or any other network-accessible device on which an SNMP agent is installed. Typically, one or more “manager” administrative computers of monitors or manages a group of hosts or devices on a computer network, each of which executes a software “agent” which reports information on the status of the device via SNMP to the manager.

The larger and more complex the managed network, the greater the demand on the managers' resources. This may greatly impact the scalability of the management solution if the system has insufficient computational resources when data synchronization occurs. In view of the foregoing, it would be desirable to reduce the resources needed to synchronize data in SNMP managed networks.

### SUMMARY

In light of the present need for efficient synchronization of data between managers and agents, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for managing the synchronization of data in a management database on a network node, the method including receiving an update request including one or more requested variables and an update tracking value, wherein each requested variable includes a requested variable identifier; determining a set of updated variables, wherein each updated variable includes an update indicator greater than the update tracking value, an updated variable identifier indicating at least one of the requested variables, and an updated variable value; and sending an update response including for each of the set of updated variables, the updated variable identifier and the updated variable value. In some embodiments, the update tracking value includes an update window. In other embodiments, the update tracking value includes a time.

In alternative embodiments, each requested variable further includes a requested variable value indicator. In further embodiments, each updated variable value includes a value that differs from a value indicated by the requested variable value indicator for the updated variable identifier. In some embodiments, the update request further includes a request identifier, and the update response further includes a response identifier indicating the request identifier. In other embodiments, the requested variable identifier includes an indication of a table row. In alternative embodiments, the requested variable identifier includes an indication of a table column.

Various exemplary embodiments relate to a method for managing the synchronization of data in a management database on a network node, the method including receiving an update request including one or more requested variables and an update tracking value, wherein each requested variable includes a requested variable identifier; determining that no requested variables have been updated; and sending an update response including an error indication. Some embodiments further include determining one or more of the requested variables caused an error, and wherein the error indication includes the requested variable identifier of the one or more requested variables that caused the error. In some embodiments, the error indication includes an indication that no requested variables have been updated. In other embodiments, the step of determining that no requested variables have been updated further includes determining that each updated variable includes an update indicator less than the update tracking value. In alternative embodiments, each requested variable further includes a requested variable value indicator. In further embodiments, the step of determining that no requested variables have been updated further includes determining that each updated variable either includes an update indicator less than the update tracking value, or includes a value that does not differ from a value indicated by the requested variable value indicator for the updated variable identifier.

It should be apparent that, in this manner, various exemplary embodiments enable synchronization of data between managers and agents. In particular, by exchanging only updated values when synchronizing databases between network managers and network agents.

### BRIEF DESCRIPTION OF THE DRAWINGS

In order to better understand various exemplary embodiments, reference is made to the accompanying drawings, wherein:

FIG. 1 illustrates an exemplary system in which a synchronization is performed;

FIG. 2A illustrates an exemplary synchronization map for an information base table column;

FIG. 2B illustrates an exemplary synchronization map for an information base table row;

FIG. 3 illustrates an exemplary extension SNMP protocol data unit (PDU);

FIG. 4 illustrates an exemplary SNMP GetResponse PDU with varibinds;

FIG. 5 illustrates an exemplary SNMP GetResponse PDU without varibinds;

FIG. 6 illustrates an exemplary structure of an information base table;

FIG. 7 illustrates an exemplary of an information base synchronization table;

FIG. 8 illustrates an exemplary hardware diagram for a device such as a manager or agent in a system.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein. Further, while various exemplary embodiments are described with regard to data synchronization in managed networks, it will be understood that the techniques and arrangements described herein may be implemented to facilitate data synchronization in other types of systems that implement multiple types of data processing or data structure.

In SNMP-based network management systems, managers administratively monitor network-attached devices provided an SNMP agent is installed on the device or a device communicatively connected to the device. A system my include one or more managers monitoring or managing a group of hosts or devices on a computer network. Each agent reports information on the status of network components via SNMP to the manager(s) using SNMP messaging.

Configuration and status data of components managed in SNMP are exposed as variables organized hierarchically. Devices can be remotely managed and configured by reporting and remote modification of these variables. Hierarchies and other metadata such as variable types and descriptions are described by Management Information Bases (MIBs). Because in SNMP managed objects or devices are represented by variables defined in an SNMP MIB, the two concepts of managed devices and the variables identifying them are used somewhat interchangeably herein; for example, an “interface” and the variable “ifTable”. MIBs are typically but not necessarily used to manage devices using SNMP, but may also manage devices using other network management models. By having a flexible namespace that facilitates the dynamic creation of new variables with different properties to be added to the dataset under maintenance, MIBs enable extensibility in SNMP and other network management models.

MIBs are not unique to SNMP-based systems, and there are a large number of MIBs defined by standards organizations like the IETF, private enterprises and other entities. SNMP MIBs typically use notation defined by Structure of Management Information Version 2 (SMIv2, RFC 2578), a subset of Abstract Syntax Notation One (ASN.1). To describe the hierarchical structure and variables of each managed device or group of devices, MIBs use a hierarchical namespace of object identifiers (OIDs), each of which identifies a variable corresponding to a status and/or configuration that can be read and/or set via SNMP. As noted above, variables identify each object, which may be a managed device or component, or a subset or collection of these. When an object is in a SNMP PDU (defined below), the conventional notation “varbind” is used to represent the object ID (OID) and its corresponding ASN.1 value.

SNMP uses an application layer protocol for communication between managers and agents. Specifically, seven protocol data units (PDUs) are used to communicate modifications and status updates (five original to the protocol and two added in later versions). Each SNMP PDU includes the following fields: IP header, UDP header, version, community, PDU-type, request-id, error-status, error-index, and variable bindings. The seven PDUs are “GetRequest,” (manager-to-agent request to retrieve the value of a variable or list of variables; returns a Response with current values); “SetRequest” (manager-to-agent request to change the value of a variable or list of variables; returns a Response with current/new values for the variables); “GetNextRequest” (manager-to-agent request to discover available variables and their values; returns a Response with variable binding for the next variable in the MIB; the entire MIB of an agent can be walked by iterative application of GetNextRequest starting at OID 0, or rows of a table can be read by specifying column OIDs in the variable bindings of the request); “GetBulkRequest” (manager-to-agent request for multiple iterations of GetNextRequest; returns a Response with multiple variable bindings walked from the variable binding or bindings in the request) (added in later versions); “Response” (returns variable bindings and acknowledgement from agent to manager for GetRequest, SetRequest, GetNextRequest, GetBulkRequest and InformRequest, including error reporting (error-status and error-index fields)); “Trap” (asynchronous unsolicited notification sent from agent to manager to notify of significant events); and “InformRequest” (acknowledged asynchronous notification, from manager to manager or agent to manager; added in later versions because SNMP commonly runs over UDP where delivery is not assured and dropped packets are not reported, delivery of a Trap is not guaranteed; sometimes referred to herein simply as an “Inform”).

According to the standard, communication takes place in the Application Layer of the Internet Protocol Suite (Layer 7 of the OSI model), where an SNMP agent receives requests on UDP port 161 (the manager may send requests to an agent from any available source port to port 161), and the agent response will be sent back to the source port on the manager. Notifications such as Traps and InformRequests are received by the manager on port 162; the agent may generate notifications from any available port. Although these ports are standardized, in specific implementations they may be altered, for example by vendors or users such as network administrators.

The SNMP manager's database of managed objects must be kept in synchronization with the MIBs in remote SNMP agents, so that changes to status of each device under management is communicated to the manager, and the manager can send updates such as configuration changes to the agents based on known device configurations. Depending on the amount of data to be updated, keeping data for a network element synchronized in an MIB database can be extremely demanding in terms of computational resources, and in fact is typically one of the most resource consuming tasks in a network managed by a SNMP system. For example, when a manager detects some modification in the MIB of a remote SNMP agent, in order to verify that the status of the managed device is known, in some circumstances the manager has to get the new value of the modified object and all the values of any other objects correlated with it, for instance through a “GetNextRequest” or “GetBulkRequest”—if the modified object has many dependencies and/or there are many modified objects at once, large numbers of messages may be exchanged and processed, such that resources such as computing, active memory, storage, and network resources may become constrained. This problem is particularly acute in cases where all the MIB tables from the remote SNMP agent must be retrieved, such as when a node reboots or is updated; sequences of tasks to update all the objects in the manager's database will be triggered leading to high CPU and memory consumption.

Each agent sends information related to the device or devices it monitors. In order to conserve resources, in many cases the agent will send updates reflecting only the variables related to the changes, rather than transmitting the entire device status every time a change occurs. In conventional systems, agents will continue to send messages continuously without waiting for a response from the intended manager, and if a manager becomes overwhelmed and cannot keep up with processing all incoming update messages, it will simply let the incoming messages drop, and may request additional information when additional resources become available at the manager. In some instances where updates have been lost and a manager requests updates, an agent may send only information updated since the manager stopped processing incoming messages, but in some instances where the agent has lost track of the updates, data regarding all settings for that agent may be sent so that the manager has a complete status for the agent. In the best case, dropped updates must be sent by the agent twice; in the worst case, all variables for each updating agent must be transmitted, rather than only updated variables. There are some middle cases, such as, for example, where Trap messages are numbered and a manager can determine that there are gaps between the index of the last Trap received/processed and the index of an incoming Trap. Regardless of how it is detected that messages have dropped, update messages will be sent more often when a manager becomes too busy to process incoming messages.

As noted above, in a network management system implemented using SNMP, one or more managers may manage a device or group of devices on a network (or object or group of objects, particularly in the case of virtualization), each of which includes an agent which reports information on the status of the device to the manager(s). Conventionally, each agent maintains a local MIB, and a manager maintains a database or repository of the MIBs of the agents it manages. Thus, the management database must be synchronized as agent devices are updated, added, deleted, or rebooted.

Depending on the amount of data to be updated, synchronizing network element data in a manager's database may be extremely demanding in terms of computational resources. Resource bottlenecks in synchronization are related to the number of exchanged variables or SNMP managed objects during the synchronization of the manager's database with the agent's MIB.

The process of synchronizing SNMP tables within a manager with corresponding MIBs in each agent may be optimized in a number of ways. One example may be the addition of extension PDU definitions which may be used by a manager during polling based synchronization to periodically send an agent requests for objects in a table column or table row containing that different values from the ones in the manager's database, where an agent's reply may contain only objects that are outdated in the manager's database rather than all the objects of the table column or the table row (as is conventionally done by SNMP polling), potentially avoiding transactions that do not communicate any updates. Another example may be the definition of two MIBs within the manager and/or agent, one which may be used to control the events in an event-driven synchronization, and another which may be used to establish dependency relations between variables in table columns or table rows. Coordinating data synchronization between a manager and agents enables the establishment of synchronization policies that may be defined to improve the network's performance.

The effects of these synchronization improvements include reducing the number of variables exchanged and SNMP objects managed during the synchronization of a manager's database with an agent's MIB, which as noted may be a major bottleneck to keeping both manager and agent synchronized. As a result, manager and agent resource consumption may be reduced by avoiding unnecessary processing which consumes memory and CPU resources. As such, SNMP management becomes more scalable because a greater number of, and more complex, network elements may be managed using the same amount of resources.

Two types of synchronization may be described, polling based synchronization and event-driven synchronization. With polling based synchronization, the SNMP manager may be responsible for interrogating the agent every time a new update is needed. With event-driven synchronization, the agent may send an event to the manager every time a new update happens. Event-driven synchronization generally requires fewer networking and processing resources, at least in part because during polling based synchronization these resources are used to interrogate the agent even when there is no update. However, event-driven synchronization can result in over-utilization in manager resources when large numbers of update messages arrive in a short period of time. Thus, each method may be preferable under different conditions depending at least upon the network configuration, performance requirements, and current status. For example, rebooting and updating of devices, particularly network equipment, may be a scenario in which polling based synchronization is typically preferred, because instead of having a burst of notifications which may overwhelm manager resources (as a large set of managed objects are being updated), the manager may selectively synchronize by polling for updates when resources are available to process them. After a reboot and/or upgrade is complete, and comparatively fewer messages must be received and processed, the synchronization may be switched to event-driven synchronization.

In polling based synchronization an SNMP manager may be responsible for interrogating an agent every time a new update is needed, but there is no way for the manager to know if the agent has any updated variables at all, or which variables have been updated. Further, because in Trap-based messaging the agent may not receive a confirmation that an update notification was received, and even in Inform-based messaging a confirmation message may be lost, an agent may not know whether a manager has received an update, and thus may not know which updates to send upon request. Thus, a metric may be used that is tracked by both an agent and its managers to verify that updates pertain to the latest synchronized data. Simply tracking individual trap gaps may be overly simplistic in a complex system where later-arriving updates may not be affected by earlier updates; as an alternative in polling based synchronization, an agent may track status changes according to a sliding or increasing metric, and a manager may request updates based upon that metric.

For example, as described further below, polling may be based on time synchronization, where an agent uses the latest updated time of the values in a particular table column or a table row to distinguish different versions. In another example, polling may be based on update windows, where an agent may maintain a synchronization map which indicates what table columns or table rows were most recently updated.

In order to track MIB tables and rows, changes may be made to MIB tables and messaging. For instance, in order to implement polling synchronization using time synchronization or update windows, additional PDUs may be defined. These additional “synchronization” PDUs may be sent by the manager to the agent to request updates on MIB variables. Synchronization PDUs may extend the SNMP protocol in order to provide support for polling based synchronization where the status of variable updates may be tracked.

Synchronization PDUs may be used by the manager to periodically request that the agent send updates for objects in a table column or table row containing different values from the ones in the manager's database. The agent's reply may contain only objects that are outdated in the manager's database rather than all the objects of the table column or the table row may be done by standard SNMP polling, therefore avoiding transactions that do not communicate updated information. Although the SNMP standard does not identify rows using an OID, for the purpose if identifying a row in an SNMP table the OID of the first attribute in the table entry may be used because it contains the table OID and the row index part (for example, the format of OID of an attribute with <attr index> in a table row may be: <table entry OID> followed by <attr index> followed by <row index>—thus the <table entry OID> and <row index> may be used to identify each row.

Also, where polling is based on time synchronization, the agent may keep the updated times for each variable in columns or rows in a modified standard MIB; note that, not all aspects of MIBs may need to be modified and the standard tables may be used because time-stamping is already contemplated in the SNMP standard MIBs for some variables where the related data has a time requirement, for example, the standard MIB ipAddressTable contains a time-based variable ipAddressLastChanged that may be used to track the update time of each row of the ipAddressTable (which regardless of the polling method used may be required for purposes of network addressing implementations).

Where polling is based on an update window only the agent's SNMP stack may be modified in order to implement the synchronization map as described below. Specifically, for polling based on update window, a synchronization map may be implemented in the agent. Because agents and managers from different vendors may need to communicate, the new synchronization PDUs may be standardized and/or published; synchronization PDUs may be considered the standard interfaces for synchronization maps. On the other hand, provided synchronization messages adhere to the standard interfaces, the internal description of the synchronization map may differ between implementations. Although the internals of synchronization maps are left up to each particular SNMP stack implementation, exemplary implementations are provided below.

Referring now to the drawings, in which like numerals refer to like components or steps, there are disclosed broad aspects of various exemplary embodiments.

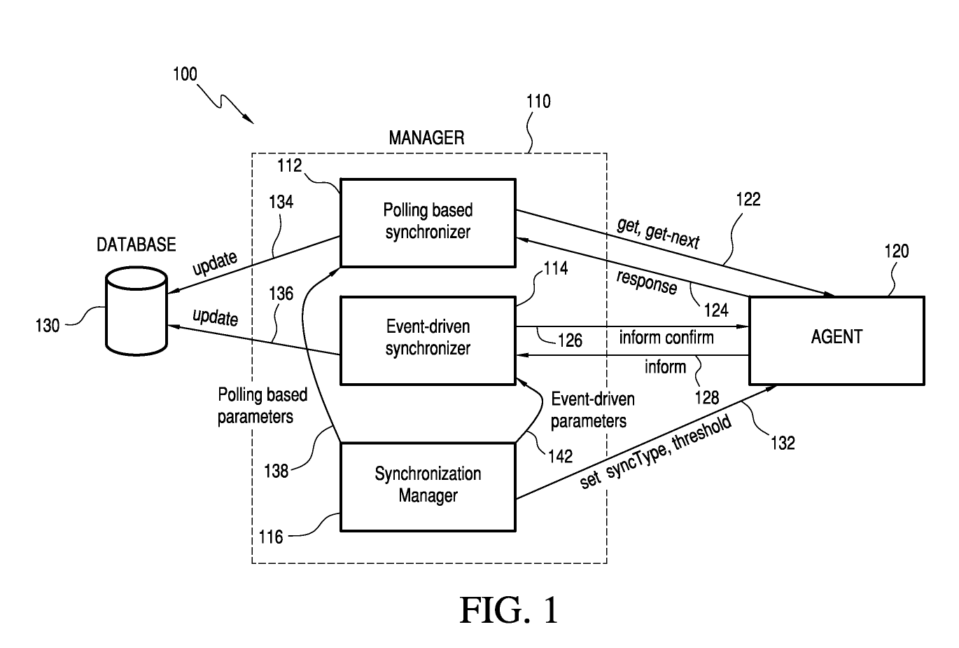

FIG. 1 illustrates an exemplary system 100 in which a synchronization is performed between a manager 110, an agent 120, and a database 130. The arrangement of system 100 may be arranged differently than shown in FIG. 1—for example, manager 110, agent 120, and database 130 may be located on the same system, or may be located on two or more systems. Further, there may be multiple agents, managers, and databases in a system 100. Typically, a manager 110 may be responsible for keeping the database 130 updated, an agent 120 may be in a network node containing an MIB, and a database 130 may be the repository of the copied or derived representation of the MIB data in the agent 120.

A manager 110 may contain three modules—a polling-based synchronizer 112, an event-driven synchronizer 114, and a synchronization manager 116. As noted above, in polling-based synchronization the manager 110 may request updates 122 from an agent 120 when an update is needed, and in event-driven synchronization an agent 120 may send an event to a manager 110 every time a new update occurs.

Polling based synchronizer 112 may manage polling-based synchronization tasks in SNMP, and may respond to commands sent using synchronization messages 138 (described further below) received from the synchronization manager 116 to modify polling configurations such as the length of each polling period, which variables may be polled, which agents may be polled, etc. For example, polling based synchronizer 112 may send SNMP GetRequest or GetNextRequest messages 122 to an agent 120 when a manager 110 needs an update, and handle the response 124 sent by the agent 120, which may be in the form of an SNMP Response message 124. Polling based synchronizer 112 may handle one or more responses 124 by sending to a database 130 updates 134 received and compiled during polling based synchronization.

Event-driven synchronizer 114 may manage event-driven synchronization tasks using standard SNMP messages as well as respond to commands sent using synchronization messages 142 (described further below) received from the synchronization manager 116 to alter synchronization parameters such as changing the size of event buffers, stop handling events (preparatory to changing to polling based synchronization), etc. For example, Event-driven synchronizer 114 may receive InformRequest messages 128 and in response to each send a confirmation message 126 that the message 128 was received. In addition, Event-driven synchronizer 114 may send to a database 130 updates 136 received and/or compiled during event driven synchronization.

Synchronization manager 116 may manage the synchronization by, for example, monitoring the number of messages received by manager 110, sending parameter messages 138, 142 to the polling based synchronizer 112 and event-based synchronizer 114 to modify synchronization configurations, and send synchronization type (event-driven or polling), variables, and thresholds to one or more agents 120 using extended SNMP messages 132. Synchronization manager 116 may be configured with synchronization policies via a user interface, a configuration file, or by an automatic process.

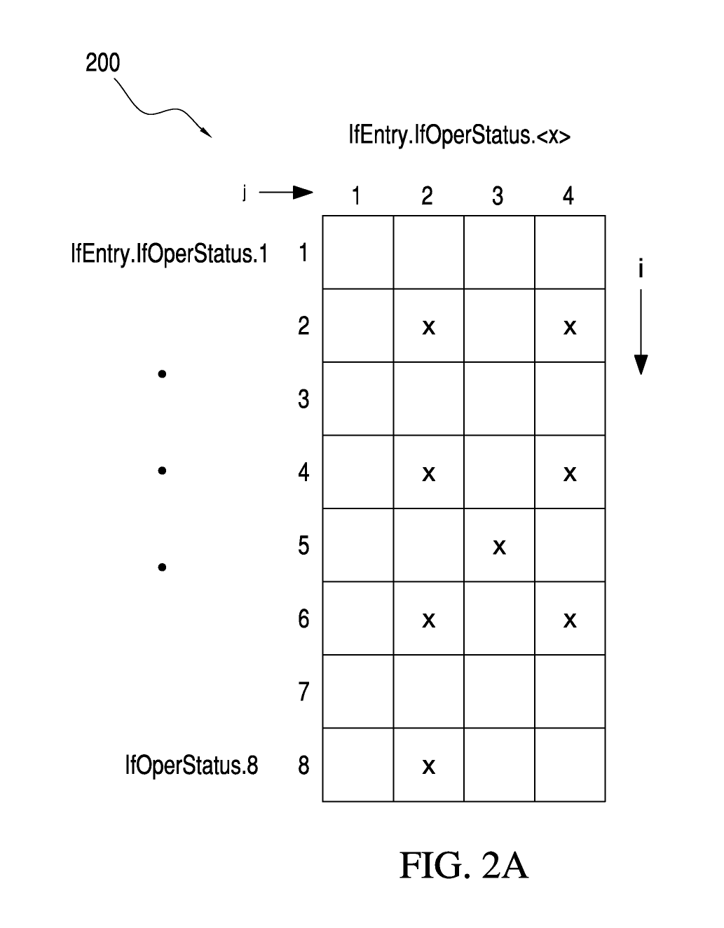

FIG. 2A illustrates an exemplary synchronization map 200 for an MIB table column. FIG. 2B illustrates an exemplary synchronization map 250 for an MIB table row. Data in SNMP MIB tables may be structured in rows and columns. Data synchronization may be carried out in batches variable by variable through a table column or table row. Cell by cell synchronization as individual updates occur may also be possible, but is not subject to optimization; thus synchronization operations sending updates over columns or rows are described herein.

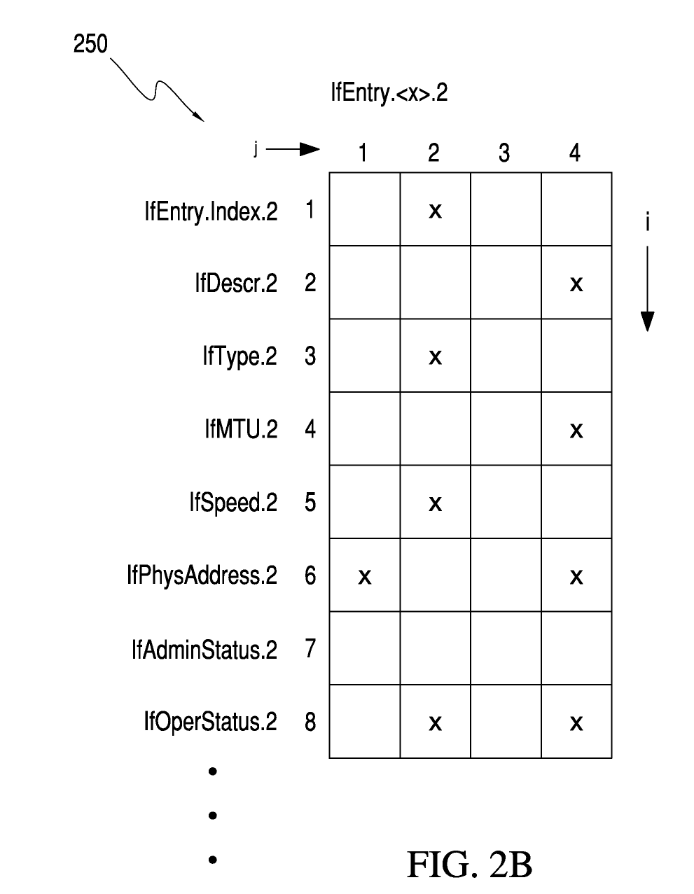

FIG. 3 illustrates an exemplary extension SNMP PDU 300 that may be an exemplary Sync-TableColumnRequest pertaining to MIB table columns or an exemplary Sync-TableRowRequest pertaining to table rows. To enable polling-based synchronization, two new synchronization SNMP extension PDUs may be defined, Sync-TableColumnRequest and Sync-TableRowRequest. Sync-TableColumnRequest may apply to updates requested and sent for table columns, and Sync-TableRowRequest may apply to updates requested and sent for table rows. Which PDU is used may depend on several factors. For example, the manager may issue a Sync-TableColumnRequest PDU when it knows the exact OID of the table column to retrieve, and may issue a Sync-TableRowRequest when it knows the exact OID of the table row to retrieve.

A synchronization map may be implemented as a bitmap in the agent. The bitmap may represent masks indicating recent updates for a MIB table row or for a MIB table column. A synchronization map 200, 250 may have two dimensions i, j, where the value of a bit (i, j), e.g. (2,2) is a Boolean value. Dimension j may represent the update order in the update window.

The significance of dimension i may differ depending on the type of synchronization kept by the synchronization cache. Where the synchronization map 200 is kept for table columns, which may correspond to a variable, dimension i may represent the rows of the SNMP table column, for example, ifEntry indexes. For example, in FIG. 2A, if a true bit indicates an update and the row corresponding to ifEntry.IfOperStatus.8 was updated in the update window corresponding to j=2, the bit (8,2) will be true.

Where the synchronization map is kept for table rows, for example, all of the variables for an update, the first dimension may represent the columns of the SNMP table rows. For example, i=2 may indicate changes to a variable of the second row for a table ifEntry.<x>.2 250. As a further example, in FIG. 2B, if 2B reflects the same updates as FIG. 2A, and if a true bit indicates an update and the column i=8 corresponds to ifEntry.IfOperStatus.2, the bit (8,2) will be true. Likewise, i=7 may correspond to ifEntry.ifAdminStatus.2.

During polling based synchronization using an update window, a manager may send a synchronization PDU to an agent indicating an update window u. The corresponding synchronization map index j may be calculated based on the following expression:

j=u_{c}−u, if u_{c}−u<uw (1)

j=uw, otherwise
where u_{c} is a counter that keeps the current update window, and is increased in the agent every time a new column in the synchronization map is updated, such that it is shifted to the next column to be updated in the next to column update; and uw is the size of the update window.

The agent may calculate what variables should be sent to the manager based upon the value of i and the synchronization map. For example, if the synchronization map 250 in an agent maintains the synchronization of the first row of an MIB table, u_{c}=65 and uw=4, the manager sends to the agent a Sync-TableRowRequest PDU with update window u=63, and the agent has the following mapping to associate i values with the synchronization map:

i=1->ifIndex(1)

i=2->IfDescr(2)

i=3->IfType(3)

i=4->ifMTU(4)

i=5->ifSpeed(5)

i=6->ifPhysAddress(6)

i=7->ifAdminStatus(7)

i=8->ifOperStatus(8)

etc.

then j=65−63, thus j=2, from which the agent may determine to send to the manager variables updated in j=2 and j=1, because they were updated after j=2. Based on this determination, the agent may send the new values of the following variables from table 250—bit(1,2)ifEntry.ifIndex.2, bit(3,2) ifEntry.ifType.2, bit(5,2)ifEntry.ifSpeed.2, bit(6,1)ifEntry.ifPhysAddress.2, and bit(8,2) ifEntry.IfOperStatus.2.

Note that although the synchronization maps consume memory resources in the agent, the size of the synchronization maps may be dynamically adapted depending on the agent's performance objectives during defined periods of time. For instance, by reducing or increasing the length of the default update window, the size of a synchronization map can be reduced or increased in response to any temporary memory bottlenecks in the agent. Smaller synchronization maps may result in more SNMP messages exchanged between the agent and the manager. Conversely, if the network is experiencing a temporary burst of packet losses, the size of synchronization maps in the agent may be increased to reduce the traffic between the agent and the manager; the size of the maps may be reduced when it is detected the problem is fixed, e.g. fewer packet losses are detected.

SNMP GetRequest PDUs are used by managers to request variables from agents, where the OID in each varibind identifies the variables to the agent so that it may retrieve the identified local (to the agent) values to include in the response PDU sent to the manager. A Sync-TableColumnRequest PDU or Sync-TableRowRequest PDU such as PDU 300 may include fields similar to standard SNMP PDU messages, including but not limited to PDU-type, request-id, error-status, error-index, and variable bindings (varibinds).

The PDU Type 305 may be a code to be allocated by an SNMP standard extension for each of the new PDU types, Sync-TableColumnRequest or Sync-TableRowRequest. Request Id 310 may be a unique number that may be used to distinguish between different requests and to associate them with the corresponding response. Error Status 315 may be a value used to indicate that an error occurred while the agent was processing a request. Error Index 320 may be used to provide additional information about the error indicated by Error Status 315 by identifying which variable in the list caused an error. Varibind 1 325, Varibind 2 330 (if necessary), including any number of vairbinds 335 (if necessary) up to varibind n 340 may be a simple list of variable bindings, each of which may be a value pair including an OID and a SyncValue. The SyncValue may be used by the receiving agent to determine whether to send the manager updates for the variable values indicated by the column or row identified by the OID in the pair, as follows.

Standard SNMP GetRequest PDUs themselves do not include a field for the manager to indicate to the agent the current value the manager maintains for the variable identified by the OID. The Sync-TableColumnRequest PDU and Sync-TableRowRequest PDU such as PDU 300 may contain a value portion of each varibind 325-340, with a synchronization value called SyncValue, indicating the manager's current value for a table variable, enabling the agent to determine whether the manager has the correct value for the corresponding variable in the column or row identified by the OID.

The type of synchronization, time-based or update window, may be indicated by the SyncValue's value type. The value type may vary depending on the MIB standard or variation that is used. Using an exemplary variation of the SNMPv2-SMI MIB, SyncValue with a value type of TimeTicks may indicate that polling is based on time synchronization and the value may indicate a timestamp of the latest synchronization for a given OID. The response from the agent may include only the variables that were updated after the SyncValue indicated in the Synchronization PDU sent by the manager—variables in the table column, for Sync-TableColumnRequest PDU, or variables in the table row, for Sync-TableRowRequest PDU Likewise, a SyncValue with a value type of Counter32 or Counter64 may indicate that polling is based on update window synchronization and the value may indicate a particular window in the synchronization cache (for a table column or table row).

If PDU 300 is a Sync-TableColumnRequest PDU, Varbinds 1 through n 325-340 may be a list of variable bindings which each binding a pair of an OID and a SyncValue. The SyncValue in each pair may be used by the agent to determine the need, or not, to send the manager updates for the variables values in the column identified by the OID in the pair.

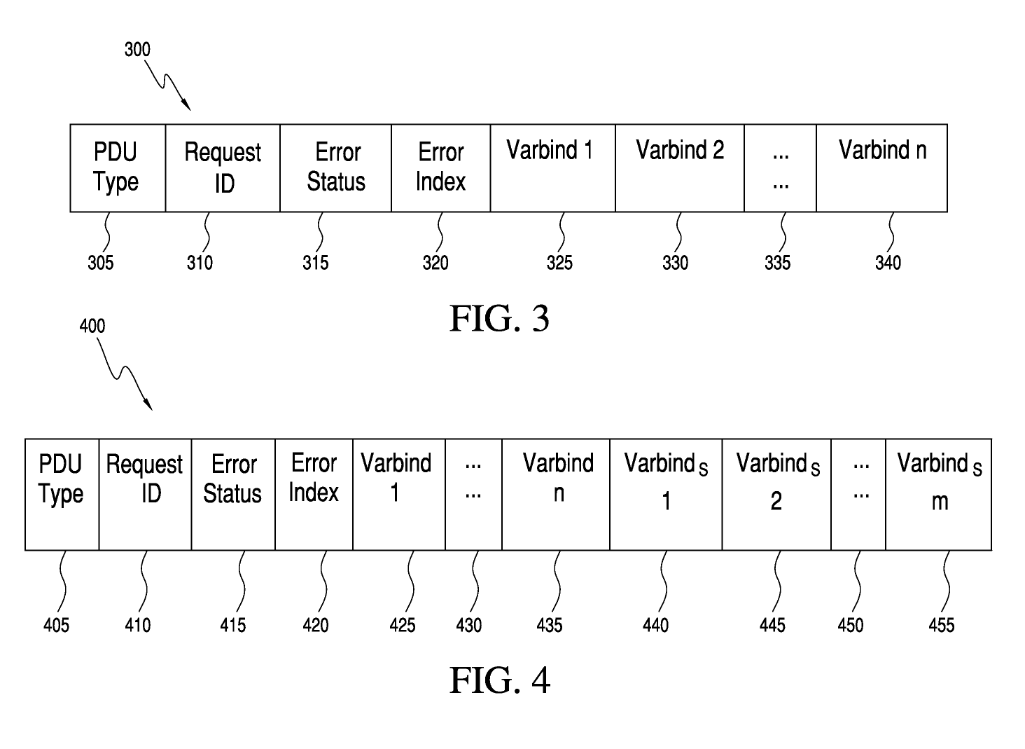

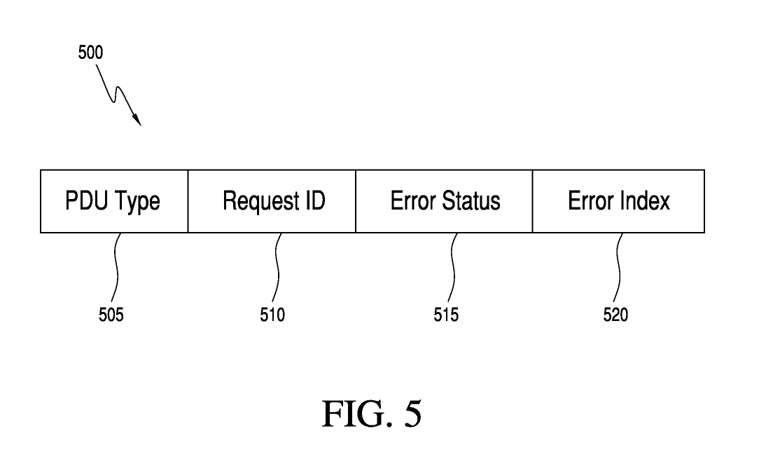

FIGS. 4 and 5 illustrate exemplary SNMP GetResponse PDUs 400 and 500. An agent that receives a Sync-TableColumnRequest PDU may reply with a standard GetResponse PDU such as PDU 400, that as a standard SNMP PDU may include PDU-type 405, request-id 410, error-status 415, error-index 420, and that may contain all the variables in each table column containing values in the agent that are more recent than the values indicated by the SyncValue, or may include an ErrorStatus 415 if an error occurs, or, if all table columns in the Sync-TableColumnRequest contain values that are the same in the agent as indicated by the SyncValue, or may reply with a GetResponse PDU such as PDU 500, including an ErrorStatus 515 with a value of “NoChange”. For example, a value “resourceUnavailable” may be returned for the Error Status field 415 if the manager sends a synchronization PDU 300 with a synchronization type 305 not supported or if a synchronization value indicated by a varibind 325-240 is not available. As with a standard SNMP message, the error index 420 may identify the table column or table row that triggered the error.

If PDU 300 is a Sync-TableRowRequest PDU, Varbinds 1 through n 325-340 may be a list of variable bindings, where the first variable binding identifies the table row which is the corresponding table entry in a MIB. For example, for the ifEntry table, the OID in the first variable may be iso(1). org(3).dod(6).internet(1).mgmt(2).mib-2(1).interfaces(2).ifTable (2).ifEntry(1). The value portion of the first variable binding corresponds to the SyncValue of the table row, and may be used by the receiving agent to determine which variable updates in the table row to send to the manager. The subsequent variables in the variable list may contain the indexes of the table entry or table row. For example, if the table uses a variable ifIndex as a table index, then the second variable 330 in PDU 300 may contain the OID iso(1).org(3).dod(6).internet(1).mgmt(2).mib-2(1).interfaces(2).ifTable(2).IfEntry(1).ifIndex(1) and an ASN.1 Integer value such as 1 to indicate the first row, 2 to indicate the second row, and so on.

An agent that receives a Sync-TableColumnRequest PDU may reply with a standard GetResponse PDU such as PDU 400, that as a standard SNMP PDU may include PDU-type 405, request-id 410, error-status 415, error-index 420, and that may contain all the variables in each table column containing values in the agent that are more recent than the values indicated by the SyncValue, or may include an ErrorStatus 415 if an error occurs, or, if all table rows in the Sync-TableRowRequest contain values that are the same in the agent as indicated by the SyncValue, may reply with a GetResponse PDU such as PDU 500, including an ErrorStatus 515 with a value of “NoChange”.

An SNMP GetResponse PDU 400 may be issued by the agent in response to Sync-TableColumnRequest PDU or Sync-TableRowRequest PDU if the request PDU 300 contains any value in its varbind list 325-340 different from the corresponding variable in the agent. However, besides the varbinds that are updated in the agent, the corresponding synchronization values may be sent in the GetResponse PDU 400 as well. In particular, GetResponse PDU 400 may include Varibinds 1 through n 425, 430, 435, corresponding to varibinds 1 through n 325-340 received in the request PDU 300 that PDU 400 is the reply for, but now the SyncValue of each varbind may reflect the agent's updated value for the corresponding variable. In addition, GetResponse PDU 400 may include the varbinds varbindₛ 1 440, varbindₛ 2 445 (if necessary), including any number of varibinds 450 (if necessary) to varbindₛ m 455, containing the new synchronization values, depending on the type of the request PDU 300 that the GetResponse PDU 400 is a reply for. For example, if PDU 400 is a reply to a Sync-TableColumnRequest PDU, varibinds 1 through m may reflect updated rows for each of the table columns identified in the request PDU 300, and if PDU 400 is a reply to a Sync-TableRowRequest PDU, varibinds 1 through m may reflect all updated variables (e.g. all updated columns) for each row identified in the request PDU 300.

An SNMP GetResponse PDU 500 may be issued by the agent in response to a synchronization PDU 300 if no SyncValue value in the synchronization PDU varbind list 325-340 is different from the corresponding variable in the agent. The ErrorStatus 515 may be “NoChange” or some other set value indicating that there are no different SyncValue values, and ErrorIndex may be equal to 0 or some other set value.

An additional benefit of Synchronization PDUs, and especially SNMP GetResponse PDU 500, is the reduction in manager resources needed to process incoming updates from an agent. Using only the standard SNMP getBulk message, because the manager and the agent cannot determine without communication the object values in each database, in the absence of other updates the manager may verify periodically (for example, every 24 hours) whether the values in its database are synchronized with the values in the agent by exchanging SNMP messages. Without synchronization PDUs, in response to a getBulk message the agent will return all variable values, which must then be processed by the manager even if the values have not changed, which may consume enormous resources. However, when synchronization PDUs are exchanged, only updated values may be sent, and an indication that no values have changed when no update is required. Thus, only updated values may be processed by the manager, for example, only values that changed in the column may be sent instead of the whole column, and the update process may not execute at all if no change is indicated.

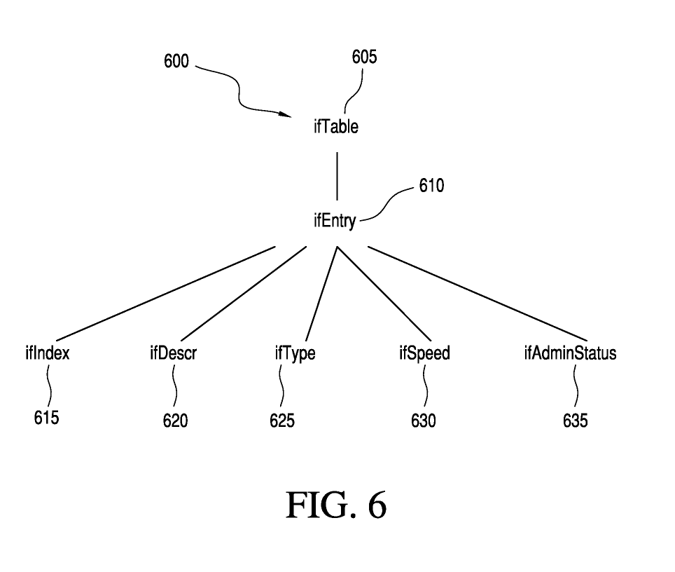

FIG. 6 illustrates an exemplary structure of an Interface table ifTable 600 which may be defined in MIB-II. Each entry ifEntry 610 in table ifTable 605 may have an OID stored in the variable ifIndex 615 (in certain data constructs, the ifEntry 610 variable may designate the row of ifEntry); variables related to the interface such as a description of the interface IfDescr 620, the type of interface IfType 625, the speed of the interface ifSpeed 630, and a variable ifAdminStatus 635.

So that agents and managers may track what methods may be used to synchronize data so that messages between them, a Synchronization MIB may be defined that may maintain information about the type of adaptive synchronization methods are available in each agent, enabling event-driven and polling based synchronization between agent and manager. This additional infrastructure may require a small increase in the memory usage of the agent to keep the new defined MIBs, but this is a slight tradeoff because by implementing these changes the number of messages exchanged between the manager and the agent may be reduced, so that the cpu-time of the agent and the manager, and the synchronization delay, may be decreased system-wide. The Synchronization MIB may be optional, but may be required for an agent to support fully optimized polling-based synchronization. As mentioned above, the current SNMP protocol already includes an MIB, so a Synchronization MIB may be implemented using definitions already within the standard. For example, SEQUENCE, INTEGER and OID (object identifier) are types already defined within the SNMP protocol. Thus, data elements within a Synchronization MIB may be created according to the specification for these types. Each Synchronization MIB may contain at least one syncTable, a SEQUENCE of syncEntry that may represent the Synchronization table, and a syncNumber, an INTEGER that may represent the number of entries in the syncTable. Before sending a Sync-TableColumn request to the SNMP agent, a manager may walk through a copy of the agent's Synchronization MIB located remotely or in proximity to the agent in order to discover for which table rows or table columns the agent is keeping synchronization information.

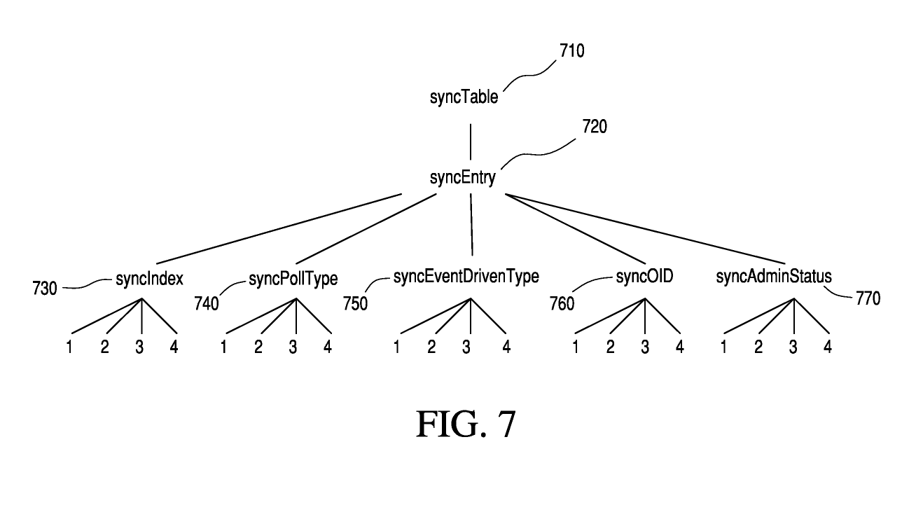

FIG. 7 illustrates an exemplary structure 700 of a syncTable 710 that may have an OID and may represent the Synchronization MIB that may be resident in an agent 120. One example of a syncEntry 720 as an entry in syncTable 710 may be a type of SEQUENCE having an OID, and may describe the synchronization monitoring of a table row or table column corresponding to an object or variable relevant to manager 110. Each syncEntry 720 may contain at least the following objects and/or variables: a syncIndex 730 which may have an OID and may be an index assigned by the agent 120 to uniquely identify syncEntry 720 in syncTable 710 (in certain data constructs, the syncEntry may designate the row of syncEntry 720); a syncPollType 740 may be an integer representing which type of polling based synchronization is supported by the agent, where 0 is not supported, 1 is none, 2 is time-based, 3 is window based, and 4 and higher may indicate support for additional techniques or other options; a syncEventDrivenType 750 may be an integer representing which type of event-driven synchronization is supported by the agent, where 0 is not supported, 1 is none, 2 is Trap-based (SNMP notification); 3 is Inform-based (SNMP Inform), and 4 and higher may indicate support for additional congestion-management techniques or other options as may be described herein; a syncOlD 760 may be an OID of the table column or table row for which the synchronization value may be kept; a syncEventThreshold (not shown) may be an integer representing how many updates are necessary before the agent sends a synchronization event, which may be dependent upon the specification of the type of synchronization indicated in syncEventDrivenType; a syncAdminStatus 770 may be an integer representing a synchronization status of the syncEntry 720, where 1 may be up or active, and 2 may be down or non-active; and a syncPriority 780 may be an integer representing a priority class of the update to be sent to the manager, which may have a range from 0 designating high priority to a higher integer from 9-99 designating low priority—depending on the complexity of the system from 10 to 100 priority classes may be established, where the priority may be set by the manager to define the relative importance of various events—for example, a manager might designate that a hardware failure condition has a higher priority than a status change of some interface.

In order to minimize the number of requests for additional information sent from a manager 110 to an agent 120, it may be preferable for an agent to be aware of dependencies between variables. So that an agent may track which objects and properties a manager considers related, such that when one object or property is updated the manager will get the status of all of the related objects or properties in the agent response, a Synchronization Dependency MIB may be defined that may maintain information about relationships between objects and properties, enabling synchronization between agent and manager. A Synchronization Dependency MIB may be optional, but when implemented, it may describe dependencies between table columns or table rows monitored through a Synchronization MIB. A Synchronization Dependency MIB may be implemented using definitions already within the SNMP standard, such as SEQUENCE, INTEGER and OID (object identifier) which are types already defined within the SNMP protocol.

Every time any object on the syncTable is updated, a dominator tree may be generated. The vertexes on the dominator tree may correspond to objects in the managed device to which the updated object might have some effect as determined by the dependency table, such that a dependency exists between them. The root of the dominator tree may represent the object being updated; the other vertexes of the tree may be representatively connected through edges associated to dependencies in the dependency table. This association may be made only if the criteria determined by a type designation in the corresponding row of the dependency table is met. Otherwise, a dominator tree may be similar in function and method of generation to a minimum spanning tree as described in related application U.S. application Ser. No. 14/502,254 filed on same date herewith, “Event-Driven Synchronization in SNMP Managed Networks,” which is herein incorporated by reference for all purposes.

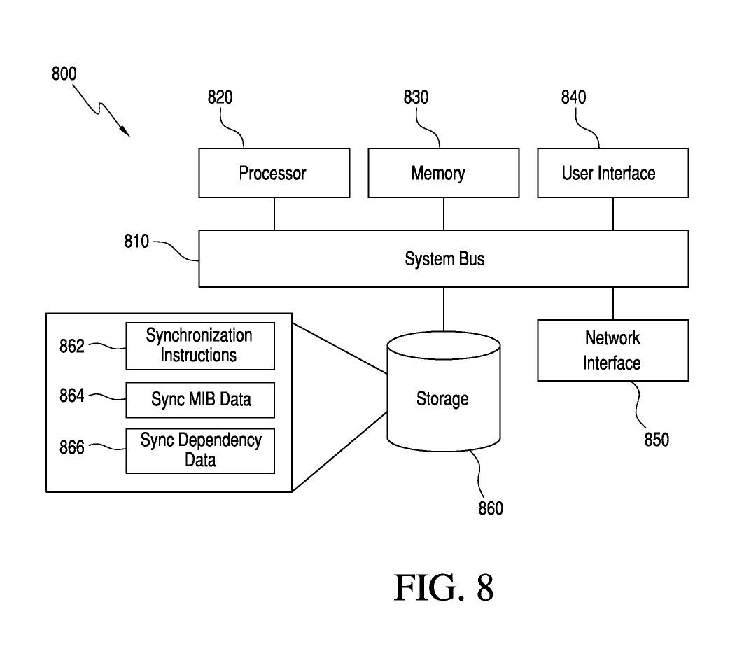

FIG. 8 illustrates an exemplary hardware diagram for a device 800 such as device including a manager or agent in a system. The exemplary device 800 may correspond to the agent 120 or manager 110 of FIG. 1. As shown, the device 800 includes a processor 820, memory 830, user interface 840, network interface 850, and storage 860 interconnected via one or more system buses 810. It will be understood that FIG. 8 constitutes, in some respects, an abstraction and that the actual organization of the components of the device 800 may be more complex than illustrated.

The processor 820 may be any hardware device capable of executing instructions stored in memory 830 or storage 860. As such, the processor may include a microprocessor, field programmable gate array (FPGA), application-specific integrated circuit (ASIC), or other similar devices.

The memory 830 may include various memories such as, for example L1, L2, or L3 cache or system memory. As such, the memory 830 may include static random access memory (SRAM), dynamic RAM (DRAM), flash memory, read only memory (ROM), or other similar memory devices.

The user interface 840 may include one or more devices for enabling communication with a user such as an administrator. For example, the user interface 840 may include a display, a mouse, and a keyboard for receiving user commands.

The network interface 850 may include one or more devices for enabling communication with other hardware devices. For example, the network interface 850 may include a network interface card (NIC) configured to communicate according to the Ethernet protocol. Additionally, the network interface 850 may implement a TCP/IP stack for communication according to the TCP/IP protocols. Various alternative or additional hardware or configurations for the network interface 850 will be apparent.

The storage 860 may include one or more machine-readable storage media such as read-only memory (ROM), random-access memory (RAM), magnetic disk storage media, optical storage media, flash-memory devices, or similar storage media. In various embodiments, the storage 860 may store instructions for execution by the processor 820 or data upon with the processor 820 may operate. For example, the storage 860 may store Synchronization instructions 862 for performing polling based or event-driven synchronization according to the concepts described herein. The storage may also store Synchronization MIB Data 864 and Dependency MIB Data 866 for use by the processor executing the Synchronization instructions 862.

According to the foregoing, various exemplary embodiments provide for optimized polling-based synchronization in a network management system. In particular, by exchanging only updated values when synchronizing databases between network managers and network agents.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for managing the synchronization of data in a management database on a network node, the method comprising:
receiving an update request comprising one or more requested variables and an update tracking value, wherein each requested variable comprises a requested variable identifier;
determining a set of updated variables, wherein each updated variable comprises an update indicator greater than the update tracking value, an updated variable identifier indicating at least one of the requested variables, and an updated variable value; and
sending an update response comprising for each of the set of updated variables, the updated variable identifier and the updated variable value.

2. The method of claim 1, wherein the update tracking value comprises an update window.

3. The method of claim 1, wherein the update tracking value comprises a time.

4. The method of claim 1, wherein each requested variable further comprises a requested variable value indicator.

5. The method of claim 4, wherein each updated variable value comprises a value that differs from a value indicated by the requested variable value indicator for the updated variable identifier.

6. The method of claim 1, wherein the update request further comprises a request identifier, and the update response further comprises a response identifier indicating the request identifier.

7. The method of claim 1, wherein the requested variable identifier comprises an indication of a table row.

8. The method of claim 1, wherein the requested variable identifier comprises an indication of a table column.

9. A method for managing the synchronization of data in a management database on a network node, the method comprising:
receiving an update request comprising one or more requested variables and an update tracking value, wherein each requested variable comprises a requested variable identifier;
determining that no requested variables have been updated; and
sending an update response comprising an error indication.

10. The method of claim 9, further comprising determining one or more of the requested variables caused an error, and wherein the error indication comprises the requested variable identifier of the one or more requested variables that caused the error.

11. The method of claim 9, wherein the error indication comprises an indication that no requested variables have been updated.

12. The method of claim 9, wherein the step of determining that no requested variables have been updated further comprises determining that each updated variable comprises an update indicator less than the update tracking value.

13. The method of claim 9, wherein each requested variable further comprises a requested variable value indicator.

14. The method of claim 13, wherein the step of determining that no requested variables have been updated further comprises determining that each updated variable either comprises an update indicator less than the update tracking value, or comprises a value that does not differ from a value indicated by the requested variable value indicator for the updated variable identifier.
